(19) United States
(12) Patent Application Publication
(10) Pub. No.: US 2026/0250607 A1
(43) Pub. Date: Aug. 27, 2026

(54) SOLVENT-BASED COMPOSITIONS FOR POST-ETCH RESIDUE REMOVAL AND RELATED METHODS

(71) Applicant: ENTEGRIS, INC., Billerica, MA (US)

(72) Inventors: Chia-Jung Hsu, Hsinchu City (TW); Chiao-Yin Hsieh, Hsinchu City (TW); Wei-Ling Lan, Hsinchu City (TW); Ming-Chi Liao, Taoyuan City (TW)

(21) Appl. No.: 19/546,180

(22) Filed: Feb. 20, 2026

Related U.S. Application Data
(60) Provisional application No. 63/764,517, filed on Feb. 27, 2025.

(51) Int. Cl. C11D 7/50; C11D 7/08; C11D 7/10; C11D 7/32

(52) U.S. Cl. CPC C11D 7/5013; C11D 7/08; C11D 7/10; C11D 7/3209

(57) ABSTRACT

Solvent-based compositions for post-etch residue removal and related methods are provided. The composition comprises a first amine halide component. The composition comprises a second amine halide component. The composition comprises a hydrogen halide component. The composition comprises an organic solvent. The organic solvent comprises a cyclic compound having at least one electron-withdrawing substituent. The organic solvent does not comprise at least one of N-methyl-2-pyrrolidone, dimethylacetamide, or any combination thereof. The first amine halide component, the second amine halide component, the hydrogen halide component, and the organic solvent are present in an amount sufficient for the composition to remove a substance at an etch rate of at least 50 Angstroms/min.

### CROSS-REFERENCE TO RELATED APPLICATIONS

This application claims the benefit under 35 USC 119 of U.S. Provisional Patent Application No. 63/764,517, filed Feb. 27, 2025, the disclosure of which is hereby incorporated herein by reference in its entirety.

### FIELD

The present disclosure relates to solvent-based compositions for post-etch residue removal and related methods.

### BACKGROUND

Chemical solutions, such as fluoride-based strippers are commonly used to remove post-etch residues during wet etching processes.

### SUMMARY

Some embodiments relate to a composition. In some embodiments, the composition comprises a first amine halide component. In some embodiments, the composition comprises a second amine halide component. In some embodiments, the composition comprises a hydrogen halide component. In some embodiments, the composition comprises an organic solvent. In some embodiments, the organic solvent comprises a cyclic compound having at least one electron-withdrawing substituent. In some embodiments, the organic solvent does not comprise at least one of N-methyl-2-pyrrolidone, dimethylacetamide, or any combination thereof. In some embodiments, the first amine halide component, the second amine halide component, the hydrogen halide component, and the organic solvent are present in an amount sufficient for the composition to remove a substance at an etch rate of at least 50 Angstroms/min.

Some embodiments relate to a method. In some embodiments, the method comprises obtaining a composition. In some embodiments, the composition comprises a first amine halide component. In some embodiments, the composition comprises a second amine halide component. In some embodiments, the composition comprises a hydrogen halide component. In some embodiments, the composition comprises an organic solvent. In some embodiments, the organic solvent comprises a cyclic compound having at least one electron-withdrawing substituent. In some embodiments, the organic solvent does not comprise at least one of N-methyl-2-pyrrolidone, dimethylacetamide, or any combination thereof. In some embodiments, the first amine halide component, the second amine halide component, the hydrogen halide component, and the organic solvent are present in an amount sufficient for the composition to remove a substance at an etch rate of at least 50 Angstroms/min. In some embodiments, the method comprises contacting a substrate with the composition to remove at least a portion of the substance from the substrate.

### BRIEF DESCRIPTION OF THE DRAWINGS

FIG. 1 is a flowchart of a method for post-etch residue removal, according to some embodiments.

### DETAILED DESCRIPTION

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “halide” refers to a —Cl, —Br, —I, or —F.

As used herein, the term “metal” refers to at least one of an alkali metal, an alkaline earth metal, a transition metal, a post-transition metal, or any combination thereof. In some embodiments, the metal comprises a metal cation. In some embodiments, the metal cation comprises at least one of a lithium cation, a sodium cation, a potassium cation, a rubidium cation, a cesium cation, a francium cation, a beryllium cation, a magnesium cation, a calcium cation, a strontium cation, a barium cation, a radium cation, a scandium cation, a titanium cation, a vanadium cation, a chromium cation, a manganese cation, an iron cation, a cobalt cation, a nickel cation, a copper cation, a zinc cation, a yttrium cation, a zirconium cation, a niobium cation, a molybdenum cation, a technetium cation, a ruthenium cation, a rhodium cation, a palladium cation, a silver cation, a cadmium cation, a hafnium cation, a tantalum cation, a tungsten cation, a rhenium cation, an osmium cation, an iridium cation, a platinum cation, a gold cation, a mercury cation, an aluminum cation, a gallium cation, an indium cation, tin cation, a thallium cation, a lead cation, a bismuth cation, a polonium cation, or any combination thereof. The charge(s) of the metal cations are known and, for simplicity, thus are not repeated here; however, it will be appreciated that the metal cations can have any known charge.

Compositions for removing residue and related methods are provided herein. The compositions provided herein can be useful for removing post-etch residue, among other types of residue, during the fabrication of microelectronic devices, including, for example and without limitation, semiconductor devices, among others. The compositions provided herein can be capable of removing post-etch residue at high removal rates, without the use of toxic substances, such as, for example and without limitation, N-methyl-2-pyrrolidone (NMP) and dimethylacetamide (DMAC), among others. The composition can exhibit at least one of a good solubility with water, a good solubility with post-dry etch residue, low safety risks during use, or any combination thereof. At least one advantage of the compositions provided herein is that the compositions offer environmentally friendly solutions, without any reduction in the performance and/or effectiveness required for the fabrication of microelectronic devices. Other advantages will be apparent from the disclosure provided herein.

The composition can comprise an organic solvent. The organic solvent can comprise a cyclic compound having at least one electron-withdrawing substituent. The cyclic compound can comprise at least one of a five-membered carbocyclic ring, a five-membered heterocyclic ring, a six-membered carbocyclic ring, a six-membered heterocyclic ring, or any combination thereof. In some embodiments, when the cyclic compound comprises a heterocyclic ring, the heteroatom(s) present in the heterocyclic ring comprise at least one of an oxygen (O), a sulfur(S), a nitrogen (N), or any combination thereof. It will be appreciated that the cyclic compound can comprise more than six atoms in the cyclic ring structure and/or less than five atoms in the cyclic ring structure, without departing from the scope of this disclosure.

The cyclic compound can comprise an electron-withdrawing substituent. The at least one electron-withdrawing substituent can comprise at least one of an oxygen (O), a nitrogen (N), a sulfur(S), a phosphorus (P), a halogen, or any combination thereof. In some embodiments, the at least one electron-withdrawing substituent comprises at least one of a nitrogen-based substituent, an oxygen-based substituent, a sulfur-based substituent, a fluorinated substituent, a phosphorous-based substituent, a halide or a halide-containing substituent, or any combination thereof. The electron-withdrawing substituent can attract hydrogen atoms of HF or HF₂, for example, to form hydrogen bonds, among other things. For example, in some embodiments, the electron-withdrawing substituent comprises at least one of a carbonyl, an ester, a ketone, an aldehyde, a nitro (—NO₂), a sulfonyl, a cyano (—CN), a sulfonamide (—SO₂NH₂), an amide, an amide-containing group (e.g., —CONH₂, a 1,3-dimethyl-3,4,5,6-tetrahydro-2(1H)-pyrimidinone, a hexamethylphosphoramide (HMPA), etc.), an amine (e.g., a pyridine, a triethylamine, etc.), a three-membered nitrogen ring (e.g., an aziridine, such as a N-tosylaziridine, etc.), a hydroxyl, an alcohol (e.g., an ethanol, an butanol, etc.), an epoxide, a sulfonate (e.g., a tosylate, a mesylate, etc.), a sulfoxide (—SO), a sulfonyl (—SO₂), a sulfone (e.g., dimethylsulfoxide (DMSO), a dimethyl sulfone (DMSO₂), a sulfolane, etc.), a perfluorinated compound (e.g., trifluoroacetic acid (TFA), perfluorooctane sulfonate (PFOS), etc.), a trifluoromethyl (—CF₃), a trifluoromethoxy (—OCF₃), a hexamethylphosphoramide (HMPA), a phosphoryl (—PO₄), a halogen (e.g., —Cl, —Br, —F, —I), or any combination thereof.

The organic solvent can form stable complexes with hydrogen fluoride by hydrogen bonding and release fluoride ions to attach to a halogen-containing residue, such as the plasma-etch residue described herein. In some embodiments, the organic solvent comprises at least one of an organic base for forming HF complexes, an amine-based hydrogen bond acceptor, an alcohol, a polyol, an acidic additive for fluoride ion release, a fluorine-containing precursor (e.g., latent HF sources), or any combination thereof.

The organic solvent can comprise an organic base that forms a stable complex with hydrogen fluoride. For example, in some embodiments, the organic solvent comprises at least one of a pyridine, a triethylamine (Et₃N), a 1,3-Dimethyl-3,4,5,6-tetrahydro-2(1H)-pyrimidinone, a hexamethylphosphoramide (HMPA), a tetramethylurea (TMU), a sulfolane (tetramethylene sulfone), or any combination thereof.

The organic solvent can comprise an amine-based hydrogen bond acceptor. In some embodiments, for example, an amine-containing compound can be useful for stabilizing HF and releasing fluoride ions under reaction conditions. In some embodiments, the organic solvent comprises at least one of an ammonia (NH₃), an ammonium fluoride (NH₄F), a tetraalkylammonium salt (e.g., tetrabutylammonium fluoride (TBAF)), a N-methyl pyrrolidone (NMP), or any combination thereof.

The organic solvent can comprise at least one of an alcohol, a polyol, or any combination thereof. In some embodiments, a hydrogen bond donor, such as an alcohol or other compound comprising a hydroxyl, can modulate HF activity and release fluoride ions. In some embodiments, the organic solvent comprises at least one of a short chain alcohol (e.g., a methanol, an ethanol, a propanol, a butanol), a long chain alcohol, a glycol (e.g., an ethylene glycol, a propylene glycol), or any combination thereof.

The organic solvent can comprise an acidic additive for fluoride ion release. For example, in some embodiments, an acidic additive can enhance HF reactivity and fluoride ion generation. For example, in some embodiments, the organic solvent comprises at least one of a triflic acid (e.g., TfOH, CF₃SO₃H, etc.), a sulfuric acid (H₂SO₄), a KHSO₄ (potassium hydrogen sulfate), or any combination thereof. The organic solvent can comprise a fluorine-containing precursor (latent HF sources). In some embodiments, a fluorine-containing precursor can generate fluoride ions or HF in situ under reaction conditions. In some embodiments, the organic solvent comprises at least one of a benzoyl fluoride (C₆H₅COF), a hexafluoropropanol (HFiPr, (CF₃)₂CHOH), a trifluoroacetic acid (TFA, CF₃COOH), a perfluorinated sulfonyl fluoride (e.g., PFOS—F), or any combination thereof.

In some embodiments, the organic solvent can comprise at least one of 3-methyl-2-oxazolidinone, dimethyl sulfoxide (DMSO), methyl acetate, or any combination thereof. The organic solvent can comprise 3-methyl-2-oxazolidinone. The organic solvent can comprise DMSO. The organic solvent can comprise methyl acetate. In some embodiments, the organic solvent comprises a solvent other than a toxic organic solvent. For example, in some embodiments, the organic solvent does not comprise at least one of N-methyl-2-pyrrolidone (NMP), dimethylacetamide (DMAC), or any combination thereof. In some embodiments, the organic solvent does not comprise a toxic organic solvent, such as NMP. The toxic organic solvent can be an organic solvent that does not meet or is regulated by local government law due to at least one of negative health risks, toxicity, negative environmental impact, disposal challenges, regulatory restrictions, or any combination thereof.

The composition can comprise 65% to 85% by weight of the organic solvent based on the total weight of the composition, or any range or subrange between 65% and 85%. For example, in some embodiments, the composition can comprise 66% to 84%, 67% to 83%, 68% to 82%, 69% to 81%, 70% to 80%, 71% to 79%, 72% to 78%, 73% to 77%, or 74% to 76% by weight of the organic solvent based on the total weight of the composition. In some embodiments, the composition can comprise 66% to 85%, 67% to 85%, 68% to 85%, 69% to 85%, 70% to 85%, 71% to 85%, 72% to 85%, 73% to 85%, 74% to 85%, 75% to 85%, 76% to 85%, 77% to 85%, 78% to 85%, 79% to 85%, 79% to 85%, 80% to 85%, 81% to 85%, 82% to 85%, 83% to 85%, or 84% to 85% by weight of the organic solvent based on the total weight of the composition. In some embodiments, the composition can comprise 65% to 84%, 65% to 83%, 65% to 82%, 65% to 81%, 65% to 80%, 65% to 79%, 65% to 78%, 65% to 77%, 65% to 76%, 65% to 75%, 65% to 74%, 65% to 73%, 65% to 72%, 65% to 71%, 65% to 70%, 65% to 69%, 65% to 68%, 65% to 67%, or 65% to 66% by weight of the organic solvent based on the total weight of the composition.

The composition can comprise a first amine halide component. The first amine halide component can comprise at least one of a primary amine halide compound, a secondary amine halide compound, a tertiary amine halide compound, or any combination thereof. The first amine component can comprise a primary amine halide compound and a secondary amine halide compound.

The first amine halide component can comprise at least one of an ammonium fluoride, an ammonium chloride, an ammonium bromide, an ammonium iodide, a tetrafluoroboric acid, a hexafluorosilicic acid, a tetramethylammonium fluoride, an ammonium hexafluorosilicate, an ammonium hexafluorotitanate, a tetrabutylammonium tetrafluoroborate, a tetraalkylammonium fluoride, or any combination thereof. For example, in some embodiments, the first amine halide component comprises an ammonium fluoride. In some embodiments, the first amine halide component comprises an ammonium chloride. In some embodiments, the first amine halide component comprises an ammonium bromide. In some embodiments, the first amine halide component comprises an ammonium iodide. In some embodiments, the first amine halide component comprises a tetrafluoroboric acid. In some embodiments, the first amine halide component comprises an hexafluorosilicic acid. In some embodiments, the first amine halide component comprises tetramethylammonium fluoride. In some embodiments, the first amine halide component comprises an ammonium hexafluorosilicate. In some embodiments, the first amine halide component comprises ammonium hexafluorotitanate. In some embodiments, the first amine halide component comprises a tetrabutylammonium tetrafluoroborate. In some embodiments, the first amine halide component comprises a tetraalkylammonium fluoride.

The composition can comprise 0.1% to 5% by weight of the first amine halide component based on the total weight of the composition, or any range or subrange between 0.1% and 5%. For example, in some embodiments, the composition can comprise 0.5% to 4% or 1% to 3% by weight of the first amine halide component based on the total weight of the composition. In some embodiments, the composition can comprise 0.1% to 4%, 0.1% to 3%, 0.1% to 2%, 0.1% to 1%, or 0.1% to 0.5% by weight of the first amine halide component based on the total weight of the composition. In some embodiments, the composition can comprise 0.5% to 5%, 1% to 5%, 2% to 5%, 3% to 5%, or 4% to 5% by weight of the first amine halide component based on the total weight of the composition.

The composition can comprise a second amine halide component. The second amine halide component can comprise a quaternary ammonium halide compound. In some embodiments, the second amine halide component comprises at least one of a tetramethylammonium fluoride (TMAF), a tetrabutylammonium fluoride (TBAF), tetraethylammonium fluoride (TEAF), tetrapropylammonium fluoride (TPAF), or any combination thereof. In some embodiments, the second amine halide component comprises a TMAF. In some embodiments, the second amine halide component comprises a TBAF. In some embodiments, the second amine halide component comprises TEAF. In some embodiments, the second amine halide component comprises TPAF.

In some embodiments, the second amine halide component comprises a compound of the formula:

R₃NX,
where:
each R is independently a hydrogen or an alkyl, and
X is Cl, Br, F, or I.

In some embodiments, each R is the same. In some embodiments, each R is different. In some embodiments, at least two Rs are the same. In some embodiments, at least one R is different. In some embodiments, at least two Rs are different.

In some embodiments, each R is a hydrogen. In some embodiments, at least one R is a hydrogen. In some embodiments, at least two Rs are a hydrogen. In some embodiments, each R is an alkyl. In some embodiments, at least one R is an alkyl. In some embodiments, at least two Rs are an alkyl.

For example, in some embodiments, the second amine halide component comprises at least one of a H₃NCl, (CH₃)₃NCl, (C₂H₆)₃NCl, H₃NBr, (CH₃)₃NBr, (C₂H₆)₃NBr, H₃NF, (CH₃)₃NF, (C₂H₆)₃NF, H₃NI, (CH₃)₃NI, (C₂H₆)₃NI, or any combination thereof. In some embodiments, the second amine halide component comprises a H₃NCl. In some embodiments, the second amine halide component comprises a (CH₃)₃NCl. In some embodiments, the second amine halide component comprises a (C₂H₆)₃NCl. In some embodiments, the second amine halide component comprises a H₃NBr. In some embodiments, the second amine halide component comprises a (CH₃)₃NBr. In some embodiments, the second amine halide component comprises a (C₂H₆)₃NBr. In some embodiments, the second amine halide component comprises a H₃NF. In some embodiments, the second amine halide component comprises a (CH₃)₃NF. In some embodiments, the second amine halide component comprises a (C₂H₆)₃NF. In some embodiments, the second amine halide component comprises a H₃NI. In some embodiments, the second amine halide component comprises a (CH₃)₃NI. In some embodiments, the second amine halide component comprises a (C₂H₆)₃NI.

The composition can comprise 0.1% to 5% by weight of the second amine halide component based on the total weight of the composition. For example, in some embodiments, the composition can comprise 0.5% to 4% or 1% to 3% by weight of the second amine halide component based on the total weight of the composition. In some embodiments, the composition can comprise 0.1% to 4%, 0.1% to 3%, 0.1% to 2%, 0.1% to 1%, or 0.1% to 0.5% by weight of the second amine halide component based on the total weight of the composition. In some embodiments, the composition can comprise 0.5% to 5%, 1% to 5%, 2% to 5%, 3% to 5%, or 4% to 5% by weight of the second amine halide component based on the total weight of the composition.

The composition can comprise a hydrogen halide component.

The hydrogen halide component can comprise at least one of a hydrogen fluoride, a hydrogen bromide, a hydrogen chloride, a hydrogen iodide, or any combination thereof. In some embodiments, the hydrogen halide component comprises a hydrogen fluoride. In some embodiments, the hydrogen halide component comprises a hydrogen bromide. In some embodiments, the hydrogen halide component comprises a hydrogen chloride. In some embodiments, the hydrogen halide component comprises a hydrogen iodide.f

The composition can comprise 0.01% to 2% by weight of the hydrogen halide component based on the total weight of the composition, or any range or subrange between 0.01% and 2%. For example, in some embodiments, the composition can comprise 0.1% to 1.9%, 0.2% to 1.8%, 0.3% to 1.7%, 0.4% to 1.6%, 0.5% to 1.5%, 0.6% to 1.4%, 0.7% to 1.3%, 0.8% to 1.2%, or 0.9% to 1.1% by weight of the hydrogen halide component based on the total weight of the composition. In some embodiments, the composition can comprise 0.1% to 2%, 0.2% to 2%, 0.3% to 2%, 0.4% to 2%, 0.5% to 2%, 0.6% to 2%, 0.7% to 2%, 0.8% to 2%, 0.9% to 2%, 1% to 2%, 1.1% to 2%, 1.2% to 2%, 1.3% to 2%, 1.4% to 2%, 1.5% to 2%, 1.6% to 2%, 1.7% to 2%, 1.8% to 2%, or 1.9% to 2% by weight of the hydrogen halide component based on the total weight of the composition. In some embodiments, the composition can comprise 0.01% to 1.9%, 0.01% to 1.8%, 0.01% to 1.7%, 0.01% to 1.6%, 0.01% to 1.5%, 0.01% to 1.4%, 0.01% to 1.3%, 0.01% to 1.2%, 0.01% to 1.1%, 0.01% to 1%, 0.01% to 0.9%, 0.01% to 0.8%, 0.01% to 0.7%, 0.01 by weight of the hydrogen halide component based on the total weight of the composition.

In some embodiments, the first amine halide component, the second amine halide component, the hydrogen halide component, and the organic solvent are present in an amount sufficient for the composition to remove a substance at an etch rate of at least 50 Angstroms/min. For example, in some embodiments, the first amine halide component, the second amine halide component, the hydrogen halide component, and the organic solvent are present in an amount sufficient for the composition to remove a substance at an etch rate of at least 60 Angstroms/min, at least 70 Angstroms/min, at least 80 Angstroms/min, at least 90 Angstroms/min, at least 100 Angstroms/min, at least 110 Angstroms/min, at least 120 Angstroms/min, at least 130 Angstroms/min, at least 140 Angstroms/min, at least 150 Angstroms/min, at least 160 Angstroms/min, at least 170 Angstroms/min, at least 180 Angstroms/min, at least 190 Angstroms/min.

In some embodiments, the first amine halide component, the second amine halide component, the hydrogen halide component, and the organic solvent are present in an amount sufficient for the composition to remove a substance at an etch rate of 50 Angstroms/min to 250 Angstroms/min, or any range or subrange between 50 Angstroms/min and 250 Angstroms/min. For example, in some embodiments, the first amine halide component, the second amine halide component, the hydrogen halide component, and the organic solvent are present in an amount sufficient for the composition to remove a substance at an etch rate of 75 Angstroms/min to 225 Angstroms/min, 100 Angstroms/min to 200 Angstroms/min, or 125 Angstroms/min to 175 Angstroms/min. In some embodiments, the first amine halide component, the second amine halide component, the hydrogen halide component, and the organic solvent are present in an amount sufficient for the composition to remove a substance at an etch rate of 75 Angstroms/min to 250 Angstroms/min, 100 Angstroms/min to 250 Angstroms/min, 125 Angstroms/min to 250 Angstroms/min, 150 Angstroms/min to 250 Angstroms/min, 175 Angstroms/min to 250 Angstroms/min, 200 Angstroms/min to 250 Angstroms/min, or 225 Angstroms/min to 250 Angstroms/min. In some embodiments, the first amine halide component, the second amine halide component, the hydrogen halide component, and the organic solvent are present in an amount sufficient for the composition to remove a substance at an etch rate of 50 Angstroms/min to 225 Angstroms/min, 50 Angstroms/min to 200 Angstroms/min, 100 Angstroms/min to 140 Angstroms/min, 50 Angstroms/min to 175 Angstroms/min, 50 Angstroms/min to 150 Angstroms/min, 50 Angstroms/min to 125 Angstroms/min, 50 Angstroms/min to 100 Angstroms/min, or 500 Angstroms/min to 75 Angstroms/min.

In some embodiments, the first amine halide component, the second amine halide component, the hydrogen halide component, and the organic solvent are present in an amount sufficient for the composition to remove a substance at an etch rate of 100 Angstroms/min to 140 Angstroms/min, or any range or subrange between 100 Angstroms/min and 140 Angstroms/min. For example, in some embodiments, the first amine halide component, the second amine halide component, the hydrogen halide component, and the organic solvent are present in an amount sufficient for the composition to remove a substance at an etch rate of 105 Angstroms/min to 135 Angstroms/min, 110 Angstroms/min to 130 Angstroms/min, or 115 Angstroms/min to 125 Angstroms/min. In some embodiments, the first amine halide component, the second amine halide component, the hydrogen halide component, and the organic solvent are present in an amount sufficient for the composition to remove a substance at an etch rate of 105 Angstroms/min to 140 Angstroms/min, 110 Angstroms/min to 140 Angstroms/min, 115 Angstroms/min to 140 Angstroms/min, 120 Angstroms/min to 140 Angstroms/min, 125 Angstroms/min to 140 Angstroms/min, 130 Angstroms/min to 140 Angstroms/min, or 135 Angstroms/min to 140 Angstroms/min. In some embodiments, the first amine halide component, the second amine halide component, the hydrogen halide component, and the organic solvent are present in an amount sufficient for the composition to remove a substance at an etch rate of 100 Angstroms/min to 135 Angstroms/min, 100 Angstroms/min to 130 Angstroms/min, 100 Angstroms/min to 125 Angstroms/min, 100 Angstroms/min to 120 Angstroms/min, 100 Angstroms/min to 115 Angstroms/min, 100 Angstroms/min to 110 Angstroms/min, or 100 Angstroms/min to 105 Angstroms/min.

In some embodiments, the composition comprises a lesser amount of the first amine halide component than the second amine halide component. For example, in some embodiments, the composition comprises 30% to 60% of a lesser amount of the first amine halide component than the second amine halide component, or any range or subrange between 30% to 60%. In some embodiments, the composition comprises 35% to 55%, 40% to 50%, 35% to 60%, 40% to 60%, 45% to 60%, 50% to 60%, 55% to 60%, 30% to 55%, 30% to 50%, 30% to 45%, 30% to 40%, or 30% to 35% of a lesser amount of the first amine halide component than the second amine halide component.

In some embodiments, the composition comprises a greater amount of the first amine halide component than the hydrogen halide component. For example, in some embodiments, the composition comprises 60% to 99% of a greater amount of the first amine halide component than the hydrogen halide component, or any range or subrange between 60% to 99%. In some embodiments, the composition comprises 65% to 95%, 70% to 90%, 75% to 85%, 60% to 90%, 60% to 85%, 60% to 70%, 60% to 65%, 65% to 99%, 70% to 99%, 75% to 99%, 80% to 99%, 85% to 99%, 90% to 99%, or 95% to 99% of a greater amount of the first amine halide component than the hydrogen halide component.

In some embodiments, the composition comprises a greater amount of the second amine halide component than the hydrogen halide component.

In some embodiments, the composition comprises a greater amount of the second amine halide component than at least one of the first amine halide component, hydrogen halide component, or any combination thereof. For example, in some embodiments, the composition comprises a greater amount of the second amine halide component than the first amine halide component. In some embodiments, the composition comprises a greater amount of the second amine halide component than the hydrogen halide component. In some embodiments, the composition comprises a greater amount of the second amine halide component than the first amine halide component and the hydrogen halide component.

In some embodiments, the composition comprises a lesser amount of the hydrogen halide component than at least one of the first amine halide component, the second amine halide component, or any combination thereof. For example, in some embodiments, the composition comprises a lesser amount of the hydrogen halide component than the first amine halide component. In some embodiments, the composition comprises a lesser amount of the hydrogen halide component than the second amine halide component. In some embodiments, the composition comprises a lesser amount of the hydrogen halide component than the first amine halide component and the second amine halide component.

In some embodiments, the weight ratio of the first amine halide component to second amine halide component to hydrogen halide component is 1:1:0.1 to 1:3:1, or any range or subrange between 1:1:0.1 and 1:3:1. In some embodiments, the weight ratio of the first amine halide component to second amine halide component to hydrogen halide component is 1:1:0.3, 1:1:0.4, 1:1:0.5, 1:1:0.6, 1:1:0.7, 1:1:0.8, 1:1:0.9, 1:1:1, 1:2:0.1, 1:2:0.2; 1:2:0.3, 1:2:0.4, 1:2:0.5, 1:2:0.6, 1:2:0.7, 1:2:0.8, 1:2:0.9, 1:2:1, 1:3:0.1, 1:3:0.2; 1:3:0.3, 1:3:0.4, 1:3:0.5, 1:3:0.6, 1:3:0.7, 1:3:0.8, 1:3:0.9, or 1:3:1.

In some embodiments, the weight ratio of the first amine halide component to the second amine halide component is 1:1.5 to 1:3, or any range or subrange between 1:1.5 to 1:3. In some embodiments, the weight ratio of the first amine halide component to the second amine halide component is 1:1.6 to 1:2.9, 1:1.7 to 1:2.8, 1:1.8 to 1:2.7, 1:1.9 to 1:2.6, 1:2 to 1:2.5, 1:2.1 to 1:2.4, 1:2.2 to 1:2.3, 1:1.5 to 1:2.9, 1:1.5 to 1:2.8, 1:1.5 to 1:2.7, 1:1.5 to 1:2.6, 1:5 to 1:2.5, 1:5 to 1:2.4, 1:5 to 1:2.3, 1:5 to 1:2.2, 1:5 to 1:2.1, 1:5 to 1:2, 1:1.5 to 1:1.9, 1:1.5 to 1:1.8, 1:1.5 to 1:1.7, 1:1.5 to 1:1.6, 1:1.6 to 1:3, 1:1.7 to 1:3, 1:1.8 to 1:3, 1:1.9 to 1:3, 1:2 to 1:3, 1:2.1 to 1:3, 1:2.2 to 1:3, 1:2.3 to 1:3, 1:2.4 to 1:3, 1:2.5 to 1:3, 1:2.6 to 1:3, 1:2.7 to 1:3, 1:2.8 to 1:3, or 1:2.9 to 1:3.

In some embodiments, the weight ratio of the hydrogen halide component to the first amine halide component is 1:2 to 1:4, or any range or subrange between 1:2 to 1:4. In some embodiments, the weight ratio of the hydrogen halide component to the first amine halide component is 1:2.1 to 1:3.9, 1:2.2 to 1:3.8, 1:2.3 to 1:3.7, 1:2.4 to 1:3.6, 1:2.5 to 1:3.5, 1:2.6 to 1:3.4, 1:2.7 to 1:3.3, 1:2.8 to 1:3.2, 1:2.9 to 1:3.1, 1:2.1 to 1:4, 1:2.2 to 1:4, 1:2.3 to 1:4, 1:2.4 to 1:4, 1:2.5 to 1:4, 1:2.6 to 1:4, 1:2.7 to 1:4, 1:2.8 to 1:4, 1:2.9 to 1:4, 1:3 to 1:4, 1:3.1 to 1:4, 1:3.2 to 1:4, 1:3.3 to 1:4, 1:3.4 to 1:4, 1:3.5 to 1:4, 1:3.6 to 1:4, 1:3.7 to 1:4, 1:3.8 to 1:4, 1:3.9 to 1:4, 1:2 to 1:3.9, 1:2 to 1:3.8, 1:2 to 1:3.7, 1:2 to 1:3.6, 1:2 to 1:3.5, 1:2 to 1:3.4, 1:2 to 1:3.3, 1:2 to 1:3.2, 1:2 to 1:3.1, 1:2 to 1:3, 1:2 to 1:2.9, 1:2 to 1:2.8, 1:2 to 1:2.7, 1:2 to 1:2.6, 1:2 to 1:2.5, 1:2 to 1:2.4, 1:2 to 1:2.3, 1:2 to 1:2.2, or 1:2 to 1:2.1.

In some embodiments, the weight ratio of the hydrogen halide component to first amine halide component is 1:4 to 1:6, or any range or subrange between 1:2 to 1:4. In some embodiments, the weight ratio of the hydrogen halide component to first amine halide component is 1:4.1 to 1:5.9, 1:4.2 to 1:5.8, 1:4.3 to 1:5.7, 1:4.4 to 1:5.6, 1:4.5 to 1:5.5, 1:4.6 to 1:5.4, 1:4.7 to 1:5.3, 1:4.8 to 1:5.2, 1:4.9 to 1:5.1, 1:4 to 1:5.9, 1:4 to 1:5.8, 1:4 to 1:5.7, 1:4 to 1:5.6, 1:4 to 1:5.5, 1:4 to 1:5.4, 1:4 to 1:5.3, 1:4 to 1:5.2, 1:4 to 1:5.1, 1:4 to 1:5, 1:4 to 1:4.9, 1:4 to 1:4.8, 1:4 to 1:4.7, 1:4 to 1:4.6, 1:4 to 1:4.5, 1:4 to 1:4.4, 1:4 to 1:4.3, 1:4 to 1:4.2, 1:4 to 1:4.1, 1:4.1 to 1:6, 1:4.2 to 1:6, 1:4.3 to 1:6, 1:4.4 to 1:6, 1:4.5 to 1:6, 1:4.6 to 1:6, 1:4.7 to 1:6, 1:4.8 to 1:6, 1:4.9 to 1:6, 1:5 to 1:6, 1:5.1 to 1:6, 1:5.2 to 1:6, 1:5.3 to 1:6, 1:5.4 to 1:6, 1:5.5 to 1:6, 1:5.6 to 1:6, 1:5.7 to 1:6, 1:5.8 to 1:6, or 1:5.9 to 1:6.

In some embodiments, the composition comprises a water. In some embodiments, the water comprises a deionized water.

The composition can comprise 10% to 30% by weight of the deionized water based on the total weight of the composition, or any range or subrange between 10% and 30%. For example, in some embodiments, the composition can comprise 11% to 29%, 12% to 28%, 13% to 27%, 14% to 26%, 15% to 25%, 16% to 24%, 17% to 23%, 18% to 22%, or 19% to 21% by weight of the deionized water based on the total weight of the composition. In some embodiments, the composition can comprise 11% to 30%, 12% to 30%, 13% to 30%, 14% to 30%, 15% to 30%, 16% to 30%, 17% to 30%, 18% to 30%, 19% to 30%, 20% to 30%, 21% to 30%, 22% to 30%, 23% to 30%, 24% to 30%, 25% to 30%, 26% to 30%, 27% to 30%, 28% to 30%, or 29% to 30% by weight of the deionized water based on the total weight of the composition. In some embodiments, the composition can comprise 10% to 29%, 10% to 28%, 10% to 27%, 10% to 26%, 10% to 25%, 10% to 24%, 10% to 23%, 10% to 22%, 10% to 21, 10% to 20%, 10% to 19%, 10% to 18%, 10% to 17%, 10% to 16%, 10% to 15%, 10% to 14%, 10% to 13%, 10% to 12%, or 10% to 11% by weight of the deionized water based on the total weight of the composition.

In some embodiments, at least one of the first amine halide component, the second amine halide component, the hydrogen halide component, or any combination thereof, is capable of undergoing hydrogen bonding with the organic solvent. In some embodiments, the hydrogen bonding can result in release of a halide from at least one of the first amine halide component, the second amine halide component, the hydrogen halide component, or any combination thereof.

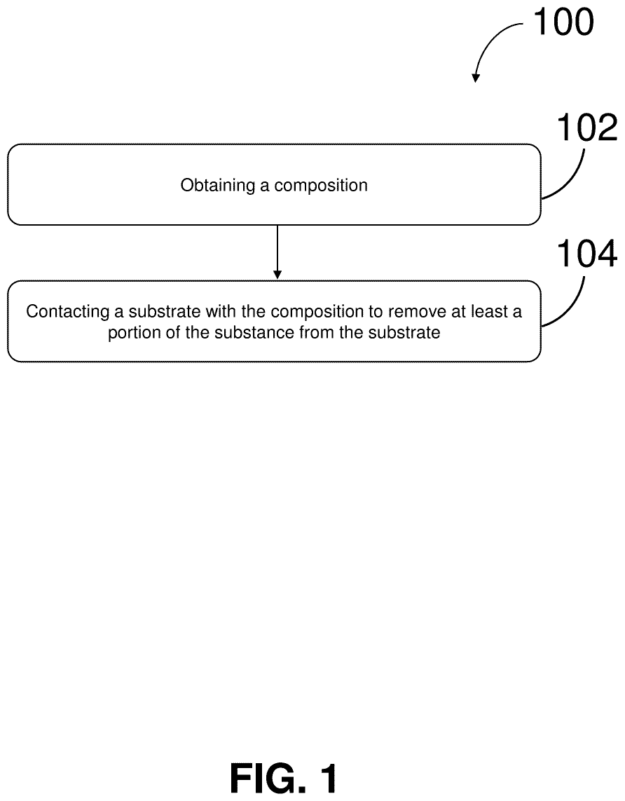

FIG. 1 is a schematic diagram of a flowchart of a method for removing a substance, according to some embodiments. As shown in FIG. 1, in some embodiments, the method comprises one or more of the following steps: obtaining 102 a composition; and contacting 104 a substrate with the composition to remove at least a portion of the substance from the substrate.

At step 102, in some embodiments, the method comprises obtaining a composition.

The composition can comprise any one or more of the compositions disclosed herein. For example, in some embodiments, the composition comprises at least one of an organic solvent, a first amine halide component, a second amine halide component, a hydrogen halide component, or any combination thereof. In some embodiments, the organic solvent comprises a cyclic compound having at least one electron-withdrawing substituent. In some embodiments, the organic solvent does not comprise at least one of N-methyl-2-pyrrolidone, dimethylacetamide, or any combination thereof.

At step 104, in some embodiments, the method comprises contacting a substrate with the composition to remove at least a portion of the substance from the substrate.

The contacting can comprise bringing the substrate and the composition into direct contact, or immediate or close proximity. For example, in some embodiments, the contacting comprises bringing the substrate and the composition into close or immediate proximity. In some embodiments, the contacting comprises bringing the substrate and the composition into direct physical contact. In some embodiments, the contacting comprises adding the substrate to the composition, or vice versa. In some embodiments, the contacting comprises mixing the substrate and the composition. In some embodiments, the contacting comprises stirring the substrate and the composition. In some embodiments, the contacting comprises agitating the substrate and the composition. In some embodiments, the contacting comprises flowing the composition through a vessel containing the substrate. In some embodiments, the contacting comprises flowing the composition over the substrate. In some embodiments, the contacting comprises shaking the composition on the substrate.

In some embodiments, the contacting comprises removing at least a portion of the substance from the substrate. In some embodiments, the contacting comprises displacing the at least a portion of the substance from the substrate. In some embodiments, the contacting comprises disassociating the at least a portion of the substance from the substrate. In some embodiments, the contacting comprises breaking a bond located between the at least a portion of the substance from the substrate. In some embodiments, the contacting comprises extracting the at least a portion of the substance from the substrate. In some embodiments, the contacting comprises releasing the at least a portion of the substance from the substrate. In some embodiments, the contacting comprises swelling at least a portion of the substance from the substrate. In the contacting comprises dissolving the at least a portion of the substance from the substrate.

The contacting can be performed for a duration sufficient to remove at least a portion of the substance from the substrate. For example, in some embodiments, the contacting can be performed for a duration of 1 second to 1 hour, or any range or subrange between 1 second and 1 hour. In some embodiments, the contacting can be performed for a duration of 5 seconds to 55 seconds, 10 seconds to 50 seconds, 15 seconds to 45 seconds, 20 seconds to 40 seconds, or 25 seconds to 35 seconds.

The composition exhibits an etch rate of at least 50 Angstroms per minute. For example, in some embodiments, the composition exhibits an etch rate of at least 60 Angstroms per minute, at least 70 Angstroms per minute, at least 80 Angstroms per minute, at least 90 Angstroms per minute, at least 100 Angstroms per minute, at least 110 Angstroms per minute, and at least 120 Angstroms per minute.

The composition exhibits an etch rate of at least 100 Angstroms per minute. For example, in some embodiments, the composition exhibits an etch rate of 100 Angstroms per minute to 250 Angstroms per minute, or any range or subrange between 100 Angstroms per minute and 250 Angstroms per minute. In some embodiments, the composition exhibits an etch rate of 110 Angstroms/min to 240 Angstroms/min, 120 Angstroms/min to 230 Angstroms/min, 130 Angstroms/min to 220 Angstroms/min, 140 Angstroms/min to 210 Angstroms/min, 150 Angstroms/min to 200 Angstroms/min, 160 Angstroms/min to 190 Angstroms/min, or 170 Angstroms/min to 180 Angstroms/min. In some embodiments, the composition exhibits an etch rate of 110 Angstroms/min to 250 Angstroms/min, 120 Angstroms/min to 250 Angstroms/min, 130 Angstroms/min to 250 Angstroms/min, 140 Angstroms/min to 250 Angstroms/min, 150 Angstroms/min to 250 Angstroms/min, 160 Angstroms/min to 250 Angstroms/min, 170 Angstroms/min to 250 Angstroms/min, 180 Angstroms/min to 250 Angstroms/min, 190 Angstroms/min to 250 Angstroms/min, 200 Angstroms/min to 250 Angstroms/min, 210 Angstroms/min to 250 Angstroms/min, 220 Angstroms/min to 250 Angstroms/min, 230 Angstroms/min to 250 Angstroms/min, or 240 Angstroms/min to 250 Angstroms/min. In some embodiments, the composition exhibits an etch rate of 100 Angstroms/min to 240 Angstroms/min, 100 Angstroms/min to 230 Angstroms/min, 100 Angstroms/min to 220 Angstroms/min, 100 Angstroms/min to 210 Angstroms/min, 100 Angstroms/min to 200 Angstroms/min, 100 Angstroms/min to 190 Angstroms/min, 100 Angstroms/min to 180 Angstroms/min, 100 Angstroms/min to 170 Angstroms/min, 100 Angstroms/min to 160 Angstroms/min, 100 Angstroms/min to 150 Angstroms/min, 100 Angstroms/min to 140 Angstroms/min, 100 Angstroms/min to 130 Angstroms/min, 100 Angstroms/min to 120 Angstroms/min, or 100 Angstroms/min to 110 Angstroms/min.

The composition can remove at least a portion of the substance from the substrate. In some embodiments, the composition removes 95% to 99.999% by weight of the substance based on a total weight of the substrate, or any range or subrange between 95% and 99.999%. For example, in some embodiments, the composition can remove at least a portion of the substance from the substrate. In some embodiments, the composition removes 96% to 99.99%, 97% to 99.9%, or 98% to 99% by weight of the substance based on a total weight of the substrate. In some embodiments, the composition removes 96% to 99.999%, 97% to 99.999%, 98% to 99% by weight of the substance based on a total weight of the substrate. In some embodiments, the composition removes 95% to 99.99%, 95% to 99.9%, 95% to 99%, 95% to 98%, 95% to 97%, or 95% to 96% by weight of the substance based on a total weight of the substrate.

In some embodiments, residue removal is determined using scanning electron microscope (SEM). In some embodiments, SEM surface imaging is useful for creating detailed images of the sample surface for a visual inspection that is used to confirm and/or measure residue removal. When using SEM surface images, a comparison of pre- and post-images can be used to determine, by visual inspection, whether the residues were removed and the extent to which residues were removed, after, for example, chemical cleaning. The substance removed can be quantified using SEM surface images by comparing pre and post images to visually determine the substance removed after applying the composition disclosed herein. In some embodiments, energy dispersive X-ray spectroscopy (EDS) is used to measure and/or identify composition of residue. For example, in some embodiments, F and C signals can be checked to evaluate the extent to which the residues were removed.

In some embodiments, the composition removes the substance in its entirety. That is, for example, in some embodiments, the composition removes the substance such that the substance cannot be detected as being present on the substrate.

The substance can comprise plasma-etch residue. The plasma-etch residue can be produced during a dry etch process to create for example, an AlCu pattern on a silicon oxide (SiOx) substrate. During dry etching, a plasma can comprise a gas comprising at least one of a boron trichloride (BCl₃), a chlorine (Cl₂), a CHX₃, wherein X is Cl or F, or any combination thereof. During a dry etch process (e.g., an aluminum metal dry etch process), “splash” can occur on, for example, sidewalls of aluminum lines. This residue can be present on the substrate, for example, the silicon oxide substrate. The residue can vary in composition. For example, in some embodiments, the residue can include organic materials from a photoresist, including, for example and without limitation, a CₓH_{y}F_{z}-containing residue. In some embodiments, the residue can include organic materials, including, for example and without limitation, inorganic compounds comprising at least one of Cl, F, O, Ti, Al, Cu, or any combination thereof. In some embodiments, the residue comprises a metallo-organic material. In some embodiments, the residue comprises a metallo-inorganic material. In some embodiments, the residue can include any combination of the foregoing residues.

In some embodiments, the plasma-etch residue comprises at least one of an organic material, an inorganic material, a metallo-organic material, a metallo-inorganic material, or any combination thereof. In some embodiments, the metallo-organic material comprises at least one of a metal-organic framework (MOFs), a Metal β-diketonates, or any combination thereof. In some embodiments, the metallo-inorganic material comprises at least one a metal oxide, a metal halide, a metal nitride, or any combination thereof.

The substrate can comprise at least one of a stainless steel, a quartz, an alumina, a ceramic, an alloy, or any combination thereof. The substrate can comprise at least one of Si, Co, Cu, AI, W, WN, WC, TiN, Mo, MOC, SiO₂, W, SiC, SiOx, SiNx, graphite, graphene, SiN, WCN, Al₂O₃, AlN, ZrO₂, La₂O₃, TaN, RuO₂, IrO₂, Nb₂O₃, Y₂O₃, hafnium oxide, or any combination thereof. The substrate can comprise other types of substrates, such as, for example, one or more of polysilicon substrates, metallic substrates, and dielectric substrates. In some embodiments, the substrate comprises at least one of at least one of aluminum, aluminum nitride, aluminum oxynitride, aluminum oxide, or any combination thereof.

The substrate can comprise silicon wafers, glass substrates, ceramic substrates (e.g., alumina, zirconia), metal foils (e.g., stainless steel, aluminum, copper), polymer substrates (e.g., polyethylene terephthalate, polyimide), quartz substrates, copper substrates, semiconductor substrates (e.g., gallium arsenide, indium phosphide), ceramic-coated substrates, plastic substrates (e.g., polycarbonate, polypropylene), metal oxide substrates (e.g., indium tin oxide), textiles, fabrics, or any combination thereof.

After the step of contacting, the method can comprise flowing the composition through a filter, so as to remove the at least a portion of the substance from the composition.

Any one or more of the embodiments disclosed herein shall be understood to be combinable without departing from the scope or spirit of the disclosure.

### Example 1

Sample 1 is an organic solvent-based composition comprising deionized water, 3-methyl-2-oxazolidinone, hydrogen fluoride, ammonium fluoride, and TMAF. Sample 1 does not comprise NMP or DMAC. Comparative Sample 1 comprises deionized water, hydrogen fluoride, triethylamine (TEA), TMAF, and 5-methyl-1H-benzotriazole (m-BTA). Comparative Sample 1 does not comprise 3-methyl-2-oxazolidinone. Comparative Sample 2 comprises deionized water, hydrogen fluoride, triethylamine (TEA), TMAF, and tetraethylammonium hydroxide (TEAH). Comparative Sample 2 does not comprise 3-methyl-2-oxazolidinone. Each of Sample 1, Comparative Sample 1, and Comparative Sample 2 were evaluated to determine their aluminum oxide etch rate and their residual removal. Each of Sample 1, Comparative Sample 1, and Comparative Sample 2 was evaluated using SEM surface images and the residue removal was determined by a visual inspection, as indicated by “clean” and “remains”. The results are shown in Table 1 below.

TABLE 1

| | | Residue |
|---|---|---|
| Name | Etch Rate (Angstroms (Å)/min) | Removal |
| Sample 1 | 116 Å/min | clean |
| Comparative Sample 1 | 10 Å/min | remains |
| Comparative Sample 2 | 9 Å/min | remains |

As shown in Table 1, by including 3-methyl-2-oxazolidinone, ammonium fluoride, TMAF, and HF in the composition, the aluminum oxide etch rate significantly increases and post-etch residue are removed.

### Example 2

Sample 1 is an organic solvent-based composition comprising deionized water, 3-methyl-2-oxazolidinone, hydrogen fluoride, ammonium fluoride, and TMAF. Sample 1 does not comprise NMP or DMAC. Sample 2 had the same composition as Sample 1 except Sample 2 had 5% more deionized water than Sample 1. Sample 3 had the same composition as Sample 1 except Sample 3 had 5% less 3-methyl-2-oxazolidinone than Sample 1. Sample 4 had the same composition as Sample 1 except Sample 4 had 5% less hydrogen fluoride than Sample 1. Sample 5 had the same composition as Sample 1 except Sample 5 had 5% less ammonium fluoride than Sample 1. Sample 6 had the same composition as Sample 1 except Sample 6 had 5% less TMAF than Sample 1. Each of Samples 1-6 were evaluated to determine their aluminum oxide etch rate and their residual removal. Each of Samples 1-6 was evaluated using SEM surface images and the residue removal was determined by a visual inspection, as indicated by “clean” and “remains”. The results are shown in Table 2 below.

TABLE 2

| Name | Etch Rate (Å/min) | Residue Removal |
|---|---|---|
| Sample 1 | 116 Å/min | clean |
| Sample 2 | 122 Å/min | clean |
| Sample 3 | 125 Å/min | clean |
| Sample 4 | 122 Å/min | clean |
| Sample 5 | 122 Å/min | remains |
| Sample 6 | 125 Å/min | clean |

By decreasing the ratio of ammonium fluoride relative to the hydrogen fluoride and the TMAF, the composition does not fully remove the residue.

### Aspects

Various Aspects are described below. It is to be understood that any one or more of the features recited in the following Aspect(s) can be combined with any one or more other Aspect(s).

Aspect 1. A composition comprising:
a first amine halide component;
a second amine halide component;
a hydrogen halide component; and
an organic solvent,
   wherein the organic solvent comprises a cyclic compound having at least one electron-withdrawing substituent,
      wherein the organic solvent does not comprise at least one of N-methyl-2-pyrrolidone, dimethylacetamide, or any combination thereof;
wherein the first amine halide component, the second amine halide component, the hydrogen halide component, and the organic solvent are present in an amount sufficient for the composition to remove a substance at an etch rate of at least 50 Angstroms/min.

Aspect 2. The composition according to Aspect 1, wherein the cyclic compound comprises at least one of a five-membered heterocyclic ring, a six-membered heterocyclic ring, or any combination thereof.

Aspect 3. The composition according to any one of Aspects 1-2, wherein the at least one electron-withdrawing substituent comprises at least one of an oxygen (O), a nitrogen (N), a sulfur(S), or any combination thereof.

Aspect 4. The composition according to any one of Aspects 1-3, wherein the organic solvent comprises at least one of 3-methyl-2-oxazolidinone, dimethylsulfoxide (DMSO), methyl acetate, or any combination thereof.

Aspect 5. The composition according to any one of Aspects 1-4, wherein the first amine halide component comprises at least one of a primary amine halide compound, a secondary amine halide compound, a tertiary amine halide compound, or any combination thereof.

Aspect 6. The composition according to any one of Aspects 1-5, wherein the first amine halide component comprises at least one of an ammonium fluoride, an ammonium chloride, an ammonium bromide, an ammonium iodide, or any combination thereof.

Aspect 7. The composition according to any one of Aspects 1-6, wherein the second amine halide component comprises a quaternary ammonium halide compound.

Aspect 8. The composition according to any one of Aspects 1-7, wherein the second amine halide component comprises a compound of the formula:

R₃NX,
where:
   R is independently a hydrogen or an alkyl, and
   X is Cl, Br, F, or I.

Aspect 9. The composition according to any one of Aspects 1-8, wherein the second amine halide component comprises at least one of a tetramethylammonium fluoride (TMAF), a tetrabutylammonium fluoride (TBAF), tetraethylammonium fluoride (TEAF), tetrapropylammonium fluoride (TPAF), or any combination thereof.

Aspect 10. The composition according to any one of Aspects 1-9, wherein the hydrogen halide component comprises at least one of a hydrogen fluoride, a hydrogen bromide, a hydrogen chloride, a hydrogen iodide, or any combination thereof.

Aspect 11. The composition according to any one of Aspects 1-10, wherein the composition comprises a lesser amount of the first amine halide component than the second amine halide component; wherein the composition comprises a greater amount of the first amine halide component than the hydrogen halide component.

Aspect 12. The composition according to any one of Aspects 1-11, wherein the composition comprises a greater amount of the second amine halide component than at least one of the first amine halide component, hydrogen halide component, or any combination thereof.

Aspect 13. The composition according to any one of Aspects 1-12, wherein the composition comprises a lesser amount of the hydrogen halide component than at least one of the first amine halide component, the second amine halide component, or any combination thereof.

Aspect 14. The composition according to any one of Aspects 1-13, wherein the cyclic compound comprises a carbonyl.

Aspect 15. A method comprising:
obtaining a composition,
   wherein the composition comprises:
      a first amine halide component;
      a second amine halide component;
      a hydrogen halide component; and
      an organic solvent,
         wherein the organic solvent comprises a cyclic compound having at least one electron-withdrawing substituent,
         wherein the organic solvent does not comprise at least one of N-methyl-2-pyrrolidone, dimethylacetamide, or any combination thereof;
      wherein the first amine halide component, the second amine halide component, the hydrogen halide component, and the organic solvent are present in an amount sufficient for the composition to remove a substance at an etch rate of at least 50 Angstroms/min; and
   contacting a substrate with the composition to remove at least a portion of the substance from the substrate.

Aspect 16. The method according to Aspect 15, wherein the contacting comprises swelling the substance on the substrate.

Aspect 17. The method according to any one of Aspects 15-16, wherein the contacting comprises dissolving the substance on the substrate.

Aspect 18. The method according to any one of Aspects 15-17, wherein the contacting is performed for a duration of 1 minute to 5 minutes.

Aspect 19. The method according to any one of Aspects 15-18, wherein the contacting is sufficient for the composition to remove the substance at the etch rate of 50 Angstroms/min to 250 Angstroms/min.

Aspect 20. The method according to any one of Aspects 15-19, wherein after contacting, the method comprises flowing the composition through a filter, so as to remove the at least a portion of the substance from the composition.

What is claimed is:

1. A composition comprising:
a first amine halide component;
a second amine halide component;
a hydrogen halide component; and
an organic solvent,
wherein the organic solvent comprises a cyclic compound having at least one electron-withdrawing substituent,
wherein the organic solvent does not comprise at least one of N-methyl-2-pyrrolidone, dimethylacetamide, or any combination thereof;
wherein the first amine halide component, the second amine halide component, the hydrogen halide component, and the organic solvent are present in an amount sufficient for the composition to remove a substance at an etch rate of at least 50 Angstroms/min.

2. The composition of claim 1, wherein the cyclic compound comprises at least one of a five-membered heterocyclic ring, a six-membered heterocyclic ring, or any combination thereof.

3. The composition of claim 2, wherein the at least one electron-withdrawing substituent comprises at least one of an oxygen (O), a nitrogen (N), a sulfur(S), or any combination thereof.

4. The composition of claim 1, wherein the organic solvent comprises at least one of 3-methyl-2-oxazolidinone, dimethylsulfoxide (DMSO), methyl acetate, or any combination thereof.

5. The composition of claim 1, wherein the first amine halide component comprises at least one of a primary amine halide compound, a secondary amine halide compound, a tertiary amine halide compound, or any combination thereof.

6. The composition of claim 1, wherein the first amine halide component comprises at least one of an ammonium fluoride, an ammonium chloride, an ammonium bromide, an ammonium iodide, or any combination thereof.

7. The composition of claim 1, wherein the second amine halide component comprises a quaternary ammonium halide compound.

8. The composition of claim 1, wherein the second amine halide component comprises a compound of the formula: 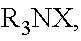
where:
R is independently a hydrogen or an alkyl, and
X is Cl, Br, F, or I.

9. The composition of claim 1, wherein the second amine halide component comprises at least one of a tetramethylammonium fluoride (TMAF), a tetrabutylammonium fluoride (TBAF), tetraethylammonium fluoride (TEAF), tetrapropylammonium fluoride (TPAF), or any combination thereof.

10. The composition of claim 1, wherein the hydrogen halide component comprises at least one of a hydrogen fluoride, a hydrogen bromide, a hydrogen chloride, a hydrogen iodide, or any combination thereof.

11. The composition of claim 1, wherein the composition comprises a lesser amount of the first amine halide component than the second amine halide component; wherein
the composition comprises a greater amount of the first amine halide component than the hydrogen halide component.

12. The composition of claim 1, wherein the composition comprises a greater amount of the second amine halide component than at least one of the first amine halide component, hydrogen halide component, or any combination thereof.

13. The composition of claim 1, wherein the composition comprises a lesser amount of the hydrogen halide component than at least one of the first amine halide component, the second amine halide component, or any combination thereof.

14. The composition of claim 1, wherein the cyclic compound comprises a carbonyl.

15. A method comprising:
obtaining a composition,
wherein the composition comprises:
a first amine halide component;
a second amine halide component;
a hydrogen halide component; and
an organic solvent,
wherein the organic solvent comprises a cyclic compound having at least one electron-withdrawing substituent,
wherein the organic solvent does not comprise at least one of N-methyl-2-pyrrolidone, dimethylacetamide, or any combination thereof;
wherein the first amine halide component, the second amine halide component, the hydrogen halide component, and the organic solvent are present in an amount sufficient for the composition to remove a substance at an etch rate of at least 50 Angstroms/min; and
contacting a substrate with the composition to remove at least a portion of the substance from the substrate.

16. The method of claim 15, wherein the contacting comprises swelling the substance on the substrate.

17. The method of claim 16, wherein the contacting comprises dissolving the substance on the substrate.

18. The method of claim 15, wherein the contacting is performed for a duration of 1 minute to 5 minutes.

19. The method of claim 15, wherein the contacting is sufficient for the composition to remove the substance at the etch rate of 50 Angstroms/min to 250 Angstroms/min.

20. The method of claim 15, wherein after contacting, the method comprises:
flowing the composition through a filter, so as to remove the at least a portion of the substance from the composition.
